(19) United States
(12) Patent Application Publication
(10) Pub. No.: US 2002/0146547 A1
(43) Pub. Date: Oct. 10, 2002

(54) END ELECTRODE STRUCTURE OF SURFACE ADHESIVE OVER-CURRENT PROTECTION DEVICE AND ITS MANUFACTURING PROCESS

(75) Inventor: Wen-Loong Liu, Pan-Chiao City (TW)

Correspondence Address: DOUGHERTY & TROXELL, One Skyline Place, Suite 1404, 5205 Leesburg Pike, Falls Church, VA, 22041, US

(73) Assignee: INPAQ TECHNOLOGY CO. LTD.

(21) Appl. No.: 09/827,236

(22) Filed: Apr. 6, 2001

(51) Int. Cl. B32B 3/00

(52) U.S. Cl. 428/209; 156/253; 156/268

(57) ABSTRACT

The end electrode structure of a kind of surface adhesive restorable voltage suppressor and its manufacturing process, especially the end electrode structure of a surface adhesive restorable voltage suppressor with polymer positive temperature coefficient (PPTC) as its main body and manufactured with film growth and electroplating processes.

### BACKGROUND OF THE INVENTION

To reduce the overvoltage occurring in electronic systems caused by abnormality and avoid the burnout of systems resulting from such overvoltage, more and more electronic systems are installed with voltage suppressors, so that the damage can be limited to them when overvoltage occurs. A further idea gives the possibility that the voltage suppressors might protect the systems affected by overvoltage and restore to their original state automatically when the abnormality is removed. This may considerably reduce the after-service or maintenance costs of the systems. Under this consideration, a restorable voltage suppressor with polymer positive temperature coefficient (PPTC) material as its main composition gradually replace the primary fusing voltage suppressor and is used widely in various electronic systems. For the application to high-density integration of electronic systems, both plug-in and surface adhesive restorable voltage suppressors are used for packaging, wherein the demand growth rate of the is much higher than that of the plug-in type.

For surface adhesive restorable voltage suppressors, the electrode structure of pins contained in this type of voltage suppressor is mainly the one made in the process of printed circuit board (PCB). It is hard for other existing component manufactures to develop surface adhesive restorable voltage suppressors with their existing component manufacturing processes and equipment. If they develop restorable voltage suppressors based on PCB process, there will be not only the problems of re-investing in processes and equipment, but also the legal problems concerning the infringement of patents.

### DESCRIPTION OF PRIOR ART

A Restorable voltage suppressors feature a kind of polymer positive temperature coefficient (PPTC) material. The temperature of voltage suppressor's main body rises when the flowing current exceeds the upper limit set for the voltage suppressor, making the originally very low resistance of the voltage suppressor rise sharply and attaining the purpose of protection by restricting the flowing current. The simplest structure of PPTC material is composed of a double layer made of PPTC material with each one metallic conducting foil on both of its front and reverse sides. Because this material is as same as that used for conventional double-side PCBs, the conventional surface adhesive restorable voltage suppressors are developed based on the conventional PCB processes in which the end electrode pin stricture of the voltage suppressors are mainly composed of the hole-electroplated conductors of the board material.

Based on the embodiment of the previous technology, the separate steps illustrated in FIG. 1 show that there is each one metallic conducting foil (11) on both the front and reverse sides as shown in FIG. 1.1. The hole (13) as shown in FIG. 1.2 is made with an automatic drilling machine on the original material board (1) of the double layer made of PPTC material (12), and then the hole (14) connecting conductor as shown in FIG. 13 is made with the hole-electroplating equipment and process to connect to the metallic conducting foils on the front and reverse sides. FIG. 1.4 shows the etching process of PCB in which the main body of the surface adhesive restorable voltage suppressor is made and the main structures are covered with green insulating paint (2) as shown in FIG. 1.5. The finished product as shown in FIG. 1.7 is finally completed by cutting the whole baseboard based on the cutting line (16) as shown in FIG. 1.6. As shown in the same figure, the end electrode structure of the surface adhesive restorable voltage suppressor is mainly formed through the hole drilling and hole electroplating processes and the connection between the two electrodes on the front and reverse sides are basically implemented by the hole conductor. Because the size of the end electrode on the component is limited, the diameter of the hole is also limited and, as a result, the performance of the end electrode resistance is restrained.

For PCB manufacturers, this structure is very simple and needs only limited costs for production. Still, it has problems to be overcome. For existing component manufacturers (such as passive component manufacturing industry), more things are to be considered to the production of surface adhesive restorable voltage suppressors based on existing PCB processes. The considerations are summarized as follows:

1. Due to the limitations of the process and equipment, the area of the original PPTC material board must be limited to a certain level, causing a considerable gap in comparison with the board area actually used in the manufacturing process of PCB. The problems of process adjustment and finance must be considered if the surface adhesive restorable voltage suppressor is to be produced with PCB process.

2.Because automatic drilling equipment and the electroplating equipment for hole electrodes are required to form the end electrode pin structure of surface adhesive restorable voltage suppressors produced with PCB hole process, manufacturers need capital for re-investment and must re-learn the new process.

3.Because it is easy and needs only limited costs to form the end electrode pin structure of surface adhesive restorable voltage suppressors with PCB hole process, early developers have applied for patents related to the manufacturing process and structure. Legal conflicts might occur if new participants use the same process technology and end electrode structure.

Based on the aforementioned description and the current demand for the application of surface adhesive restorable voltage suppressors, the said invention gives an idea for the application of the end electrode structure process of the passive resistance components that have been produced massively in the hope to form the end electrode structure of surface adhesive restorable voltage suppressors. A better feature will be showcased by connecting all the end electrodes to lower down the end electrode resistance of surface adhesive restorable voltage suppressors.

### SUMMARY OF THE INVENTION

The purpose of the said invention is to lower down the end electrode resistance for improving the protection characteristics of surface adhesive restorable voltage suppressors.

Another purpose of the said invention is to form the end electrode structure of surface adhesive restorable voltage suppressors through existing technologies and processes without the need to re-invest in new equipment or learn new manufacturing processes.

The other purpose of the said invention is to make the area of the original PPTC material board appropriately match with the area of the baseboard used in existing processes and conform to the suitability and cost-efficiency of the process for surface adhesive restorable voltage suppressors.

For more information of the detailed composition, other purposes and effectiveness of the said invention, please refer to the following description.

### DETAILED DESCRIPTION OF PREFERRED EMBODIMENTS

The said invention provides a solution (FIG. 2) for the end electrode structure of surface adhesive restorable voltage suppressors.

FIG. 2.1 shows an original material board (3) in a form of double layer (32) made of PPTC material with each one metallic conducting foil (31) on both of its front and reverse sides.

FIG. 2.2 shows that a groove (33) is formed by removing the redundant metallic conducting foil (31) on both the front and reverse sides in PCB line etching or cutting process. The main baseboard (4) of the surface adhesive restorable voltage suppressor is made in this way.

FIG. 2.3 shows the main structures coated with an insulating layer (34) in PCB process.

FIG. 2.5 shows that stripe baseboards (5) are formed by cutting the whole baseboard (4) along the cutting line (41) as shown in FIG. 2.4.

FIG. 2.6 shows that an end electrode bottom film conductor (35) is made with film growth or deposit equipment after the stripe baseboards (5) are overlapped.

FIG. 2.7 shows that welding interface layers are made by electroplating the stripe baseboards (5) with end electrode bottom film conductor (35) to form the main metallic end electrode metal structure (6).

FIG. 2.8 shows that the stripe baseboards (5) with end electrode bottom film conductors (35) undergo the cutting process along the dotted cutting line (36) as shown in FIG. 2.7. The stripe baseboards are cut to be crystals, forming surface adhesive restorable voltage suppressors.

As shown in FIG. 3, the end electrode structure of the invented surface adhesive restorable voltage suppressors has an end electrode structure of restorable voltage suppressors that is electroplated with welding interface layers (77) (78) after the end electrode bottom conductors (75) (76) of the component are formed on the double layer (7) made of PPTC material, the metallic conducting foils (71) (72) and the end faces of the insulating layers (73) (74) on the main structures are made.

### IMPLEMENTATION OF INVENTION

FIG. 2.6 and 2.7 show clearly that the end electrode bottom film conductors are formed on the two end faces of the surface adhesive restorable voltage suppressors with film growth or deposit equipment. The welding interface layers are formed on the end electrode bottom film conductors in the electroplating process. This structure can thoroughly connect the pin conductors of the end electrodes on both the front and reverse sides and minimize the resistance of the end electrode pins of the surface adhesive restorable voltage suppressors.

From the viewpoint of the manufacturing process of surface adhesive restorable voltage suppressor's end electrode structure, the practical example of the said invention is applicable to the process of the end electrode structure of passive resistance components that have be produced massively and can form the end electrode structure of the surface adhesive restorable voltage suppressors.

### EFFECTIVENESS OF INVENTION

1. The resistance of the end electrode pins of the surface adhesive restorable voltage suppressors can be minimized through the complete connection of the pin conductors on its front and reverse sides.

2.The invented process is applicable to the process of the end electrode structure of passive resistance components that have be produced massively and can form the end electrode structure of the surface adhesive restorable voltage suppressors. Manufacturers can take advantage of the existing process technology and equipment to significantly reduce the funds for developing new products and shorten the time period needed for the development. Thanks to the appropriate area of baseboards, the mass production can be realized quickly and cost efficiently.

Based on the aforementioned description, there is no any other surface adhesive restorable voltage suppressor that has the same end electrode structure as that of the invented surface adhesive restorable voltage suppressors. It must be stated that, for any person who knows the process technology of surface adhesive restorable voltage suppressors well, any change to the said invention that does not exceed the spirit of the said invention shall be regarded as covered by the said invention.

### BRIEF DESCRIPTION OF DRAWINGS

FIGS. 1.1 to 1.7 are the diagrams showing the PCB process for the end electrode structure of conventional surface adhesive restorable voltage suppressors.

FIGS. 2.1 to 2.8 are the diagrams showing the process for the end electrode structure of the invented surface adhesive restorable voltage suppressors.

FIG. 3 is the three-dimension drawing of the invented surface adhesive restorable voltage suppressors.

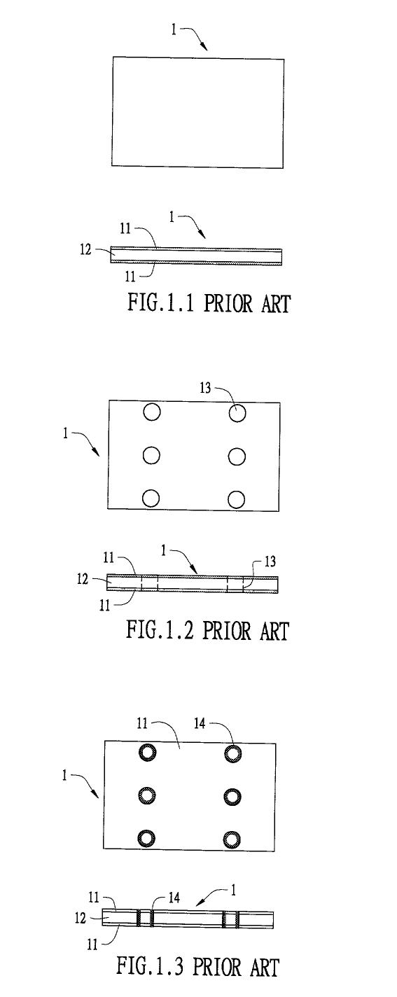

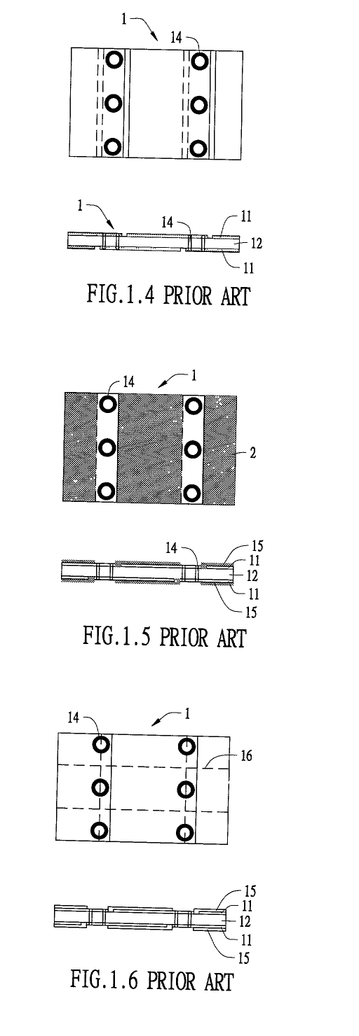

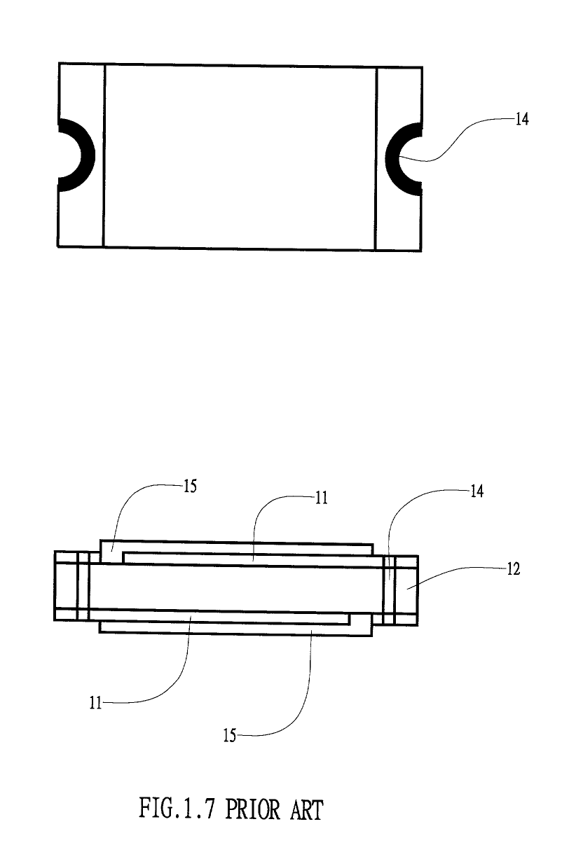

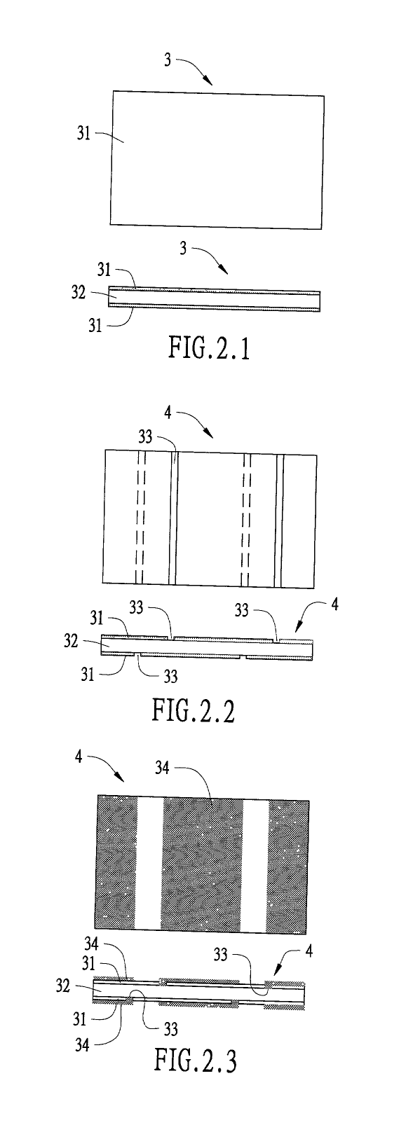

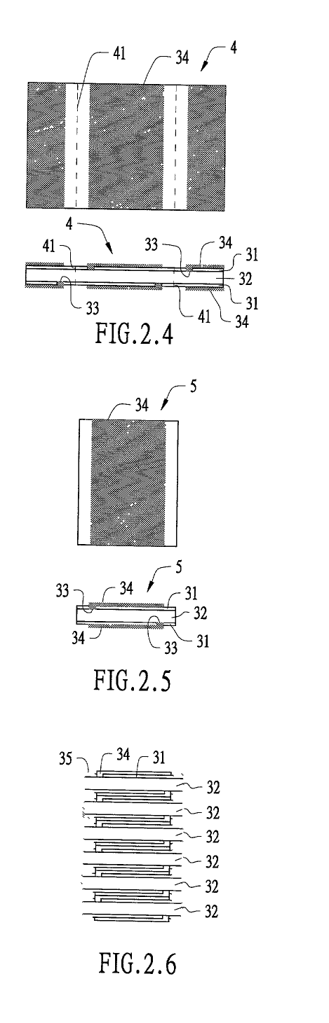

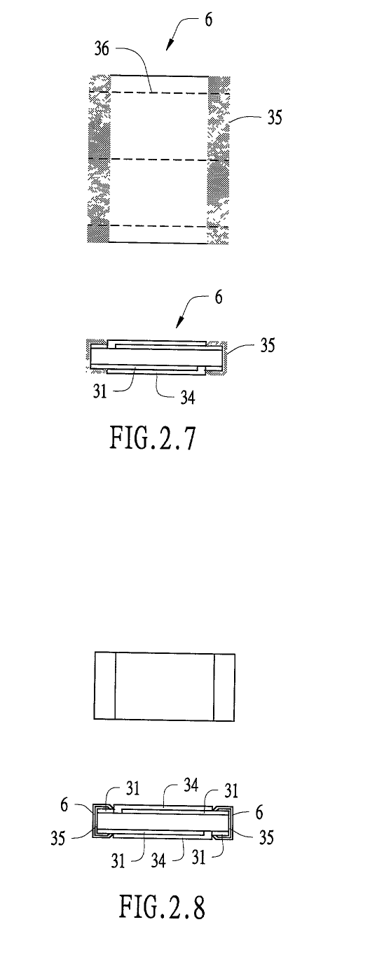

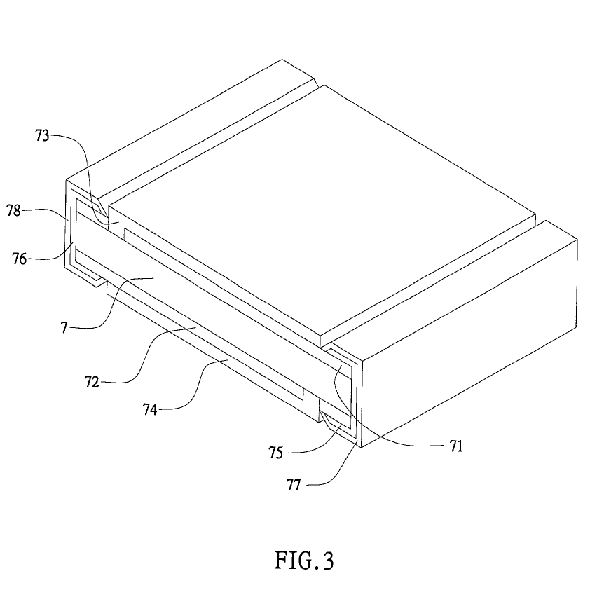

What I claim is:

1. A manufacturing process for the end electrodes of a surface adhesive restorable voltage suppressors includes: Each one metallic conducting foil on both the front and reverse sides of the double layer made of polymer positive temperature coefficient (PPTC) material. A groove (33) is formed by removing the redundant metallic conducting foil (31) in PCB line etching process for the making of baseboards as the main components of the surface adhesive restorable voltage suppressors. The baseboards are cut to be stripes after the main structures of the main components are coated with an insulation layer in PCB process. The end electrode bottom film conductors are made with film growth equipment after the stripe baseboards are overlapped, and the welding interface layer is formed by electroplating the end electrode bottom film conductors to make a metallic end electrode structure. The surface adhesive restorable voltage suppressor is finally produced by cutting the stripe metallic end electrode structure into crystals in the cutting process.

2. The manufacturing process of the end electrodes of a surface adhesive restorable voltage suppressors as recited in claim 1, wherein the groove on the metallic conducting foils can be formed in cutting process.

3. The manufacturing process of the end electrodes of surface adhesive restorable voltage suppressors as recited in claim 1, the end electrode bottom film conductors can be made with deposit equipment after the stripe baseboards are overlapped.

4. A kind of end electrode structure of surface adhesive restorable voltage suppressor includes:
One raw material board that has each one patterned conducting metal foil layers on both of its sides to form the main body baseboard of the surface adhesive restorable voltage suppressor;
Two Insulating layers that are placed on the patterned conducting metal foil layers on both sides of the main body baseboard and expose the patterned conducting foil at the edge of the main body baseboard; and
Two end electrodes that are placed on the end faces of the main body baseboard and connect with the exposed patterned conducting foil layers.

5. The end electrode structure of surface adhesive restorable voltage suppressor as recited in claim 4, wherein the raw material board has a double layer with polymer positive temperature coefficient.

6. The end electrode structure of surface adhesive restorable voltage suppressor as recited in claim 4, wherein the patterned conducting foil layers at the edge of both sides of the main bode baseboard are separated by a groove.

7. The end electrode structure of surface adhesive restorable voltage suppressor as recited in claim 5, wherein the groove is covered by the insulating layer.

8. The end electrode structure of surface adhesive restorable voltage suppressor as recited in claim 4, wherein each of the end electrodes contains:
One end electrode bottom film conductor that is placed on the exposed patterned conducting metal foil layer; and
One welding interface that is placed on the end electrode bottom film conductor.
